(19) United States
(12) Patent Application Publication
(10) Pub. No.: US 2018/0279610 A1
(43) Pub. Date: Oct. 4, 2018

(54) GLYCEROL ETHER-BASED ANTIMICROBIAL COMPOSITIONS

(71) Applicant: Randall Andrew Pilon, Oakville (CA)

(72) Inventor: Faraz AHMADPOUR, Mississauga (CA)

(21) Appl. No.: 15/944,933

(22) Filed: Apr. 4, 2018

Related U.S. Application Data
(60) Provisional application No. 62/481,154, filed on Apr. 4, 2017.

(51) Int. Cl. A01N 31/02; A01N 25/30; C02F 1/50

(52) U.S. Cl. CPC A01N 31/02; C02F 1/50; A01N 25/30

(57) ABSTRACT

A synergistic antimicrobial composition comprising, consisting essentially of, or consisting of:
a. at least one monoalkyl glycerol ether of formula I

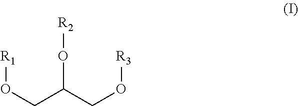

wherein any one of R1, R2 and R3 is a branched or unbranched, saturated or unsaturated C1-C24 alkyl group and the other of R1, R2 and R3 are each hydrogen; and
b. at least one nonionic surfactant having an HLB value of from about 6 to about 24;
   wherein the composition is free of bispyridiniumalkanes.

This application claims the benefit of U.S. provisional patent application 62/4811154 filed Apr. 4, 2017, the contents of which are incorporated herein by reference.

### FIELD OF THE INVENTION

The present invention relates to antimicrobial compositions and preservatives.

### BACKGROUND OF THE INVENTION

Living or inanimate surfaces can often be contaminated with various environmental pathogenic microbes. There is a need for compositions and antimicrobially-active ingredients capable of cleaning, disinfecting and/or sanitizing the surfaces effectively and safely. The majority of conventional antimicrobially-active ingredients may provide efficacy against various types of microbes; however, they often have limitations including lack of safety or toxicity, surface incompatibility, poor environmental profile, corrosiveness, malodor, high costs, poor cleaning capability, and/or lack of flexibility or versatility in formulation into a final product.

Chlorine-based oxidizer antimicrobials are corrosive, have an unpleasant odor, and can cause skin and lung irritation. They also are poor cleaners and are required to be formulated in the alkaline range of pH. Quaternary ammonium compounds exhibit poor safety and environmental profiles and are known to adhere to soft surfaces such as cotton and cellulose surfaces. Iodine-based antimicrobials can be toxic, possess poor environmental and cleaning profiles, and can discolor the surfaces on which they are used. Alcohol-based microbicidals are quick to dry from surfaces, often before the required contact time for effective disinfection is reached. They can also be a fire hazard, cause dermal and lung irritation, and be malodorous. Peracetic acid disinfectants can also be irritating and malodorous, and lack proper stability at low concentrations or at certain pH ranges. Aldehyde- and phenol-based antimicrobials are often highly toxic and also malodorous.

U.S. Pat. No. 7,481,973 B2 discloses the use of at least 0.1% wt. glycerol ether in combination with other ingredients, e.g. aldehydes, amines, phenols, halogens, carboxylic acids and aromatic alcohols, at elevated temperatures. The other ingredients can be corrosive, toxic, and unfriendly to the environment. Furthermore, the antimicrobial activity may be low, i.e. requiring contact times of 15 minutes or longer.

EP 2314162 A1 discloses compositions comprising a glycerol ether, a cationic surfactant, and one or more aliphatic alcohols. EP 1683417 A1 discloses the use of glycerol ethers in combination with pyridinium-based cationic surfactants, polyols and nonionic surfactants.

U.S. Pat. No. 5,591,442 teaches skin disinfectants comprising glycerol ethers and short chain aliphatic alcohols. EP 1369037 B1 discloses similar compositions, wherein the alcohols are aromatic aryloxyalkanols and arylalkanols. Glycerol ethers are described as a form of nonionic surfactant in EP 1740166 B1.

Phenols, aldehydes (e.g. formaldehyde) aldehyde releasing agents, carboxylic acids, ionic surfactants, and non-polyol alcohols are often incompatible with enzymes in detergent systems. These compounds can interact with the enzymatic mechanisms of action and/or the enzyme structure, causing weakening or loss of enzyme activity. The use of glycerol ethers in combination with the ingredients disclosed in the aforementioned prior art is therefore not suitable in sensitive formulations such as enzymatic cleaners. For example, EP 0268227 B1 teaches separating the enzymatic cleaning step from the antimicrobial step when reprocessing medical devices such as endoscopes, due to incompatibility between the antimicrobial ingredient(s) with the enzyme(s) used.

### SUMMARY OF THE INVENTION

The inventor has surprisingly found that antimicrobial compositions according to the invention are effective antimicrobials and/or preservatives while not possessing the aforementioned disadvantages in the prior art. The present compositions can be used in enzymatic systems, and are effective even at low concentrations.

In accordance with one aspect, the invention provides a synergistic composition comprising, consisting essentially of, or consisting of at least one glycerol ether and at least one nonionic surfactant.

The at least one glycerol ether is a monoalkyl glycerol ether according to formula I

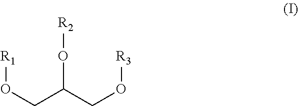

wherein any one of R1, R2 and R3 is a branched or unbranched, saturated or unsaturated, substituted or unsubstituted C1-C24 alkyl group and the other of R1, R2 and R3 are each hydrogen.
   Furthermore, the at least one nonionic surfactant has an HLB value of from about 6 to about 24.

The composition is free of cationic antimicrobial compounds, e.g. bispyridiniumalkanes, biguanides, bisbiguanides, and quaternary ammonium compounds.

In some embodiments, the at least one monoalkyl glycerol ether is selected from the group comprising 3-[(2-ethylhexyl)oxy]-1,2-propanediol, 1-dodecyl glycerol ether, 1-decyl glycerol ether and 1-heptyl glycerol ether.

The composition herein can have a range of pH from about 2, 4, 5, 6, 7, 8, or 9 and up to about 12, 11, 10, 9, 8, 7, or 5. The pH value(s) will depend on the application and selection of ingredients or compounds in the composition.

The composition can be in a variety of formats, e.g. in the form of a wipe (a textile in which the composition is embedded), powdered mixture for dissolution in a solvent (e.g. water or non-aqueous solvent) before use, or a solution. The solution can be a dilute solution (e.g. ready-to-use) or a concentrate for direct application or dilution before use. Concentrate solutions can be diluted with water or a solvent at a ratio of from 1:1 to 1:10000 (solution:water/solvent) to produce a diluted “ready-to-use” solution. In preferred embodiments, the dilution ratio can range from 1:1 to 1:1000, more preferably from 1:50 to 1:500.

In accordance with another aspect, the invention provides a method of reducing the microbial load of a surface (e.g. method of sanitizing or disinfecting a surface) which comprises, consists essentially of, or consists of applying a composition according to the first aspect to the surface for a time sufficient to reduce the microbial load. The application can be manual or using a device, with or without an added source of energy. For example, the compositions can be applied by spraying, soaking, wiping, fogging, misting, pressure washing, using an automated washing or cleaning machine, etc.

Compositions according to the invention can be formulated into a wide range of products including, without limitation, sanitizers, disinfectants, and cleaners, including those containing enzymes. In such products, the composition is used to preserve, i.e. to prevent microbial growth in the products, and/or to impart antimicrobial efficacy to the products.

The products can be used on a wide range of surfaces and in a wide range of applications, depending on the other formulation ingredients, such as for cleaning or reducing the microbial load on human or animal surfaces (including wounds, eyes and mucous membranes), plants, other soft surfaces (e.g. clothing, carpets and textiles), hard surfaces, tools, devices, machines, apparatus, food and food processing apparatus, animal enclosures and other articles, devices or environments associated with animal health, medical and dental instruments (e.g. in cleaning or reprocessing). Ready-to-use solutions according to the invention can be used, without limitation, in an ultrasonic cleaner or a basin, wherein surfaces to be cleaned are immersed. The concentrated solution can be used, without limitation, in an automatic machine which automatically dilutes and sprays the concentrated solution on the instruments to be cleaned for a period of from several seconds to several minutes.

The present compositions can be employed as preservatives, meaning to prevent decomposition of water-containing products due to microbial growth. Example products that can be preserved using compositions according to the invention include cosmetics, skin lotions, enzymatic solutions, detergents, paints, and the like

Other features or aspects of the invention will be apparent from a full reading of the specification.

### DETAILED DESCRIPTION OF EMBODIMENTS

For the sake of clarity and to avoid ambiguity, certain terms are defined herein as follows.

The term “comprising” means “including without limitation.” Thus, a composition comprising a list of ingredients may include additional ingredients not expressly recited. The term “consisting of” means “including the listed ingredients and such additional ingredients as may be present as natural or commercial impurities or additives.” Natural and commercial impurities will be apparent to the person of ordinary skill in the art. An example of a commercial additive are minute quantities of stabilizers in hydrogen peroxide commercial solutions. The term “consisting essentially of” means “consisting of the recited ingredients plus such additional ingredients as would not materially affect the basic and novel properties of the invention.” By “basic and novel properties” is meant the antimicrobial efficacy of the solution, whether in terms of degree or rate of kill, or the number or identity of microorganisms against which the composition is effective. For the sake of clarity, solutions or composition that do not materially affect the basic and novel properties are those which achieve a ≥2 log reduction against S. aureus using ASTM 2315-03 method, at 50° C. and a 5-minute contact time.

The term “weight percent,” “% wt.,” “percent by weight,” “% by weight,” “% w/w,” and variations thereof refer to the concentration of a substance as the weight of that substance divided by the total weight of the composition and multiplied by 100.

The term “about” refers to a variation in the numerical quantity that can occur, for example, through typical measuring and liquid handling procedures used for making concentrates or ready-to-use solutions in the real world or when carrying out the methods of the invention. The term “about” also encompasses the differences in the manufacture, source, or purity of the ingredients used to make the present compositions, and amounts that differ due to different equilibrium conditions or different reaction levels for a composition resulting from a particular initial mixture. For the sake of clarity, the term “about” includes variations in the expressed value of up to 5% (plus or minus). Whether a value is modified by the term “about” or not, the claims include equivalents to the values.

In the description and claims, the singular forms “a,” “an,” and “the” include plural referents unless the content clearly dictates otherwise. Thus, for example, reference to “a composition” containing “a compound” includes one or more compositions, each having one or more compounds. It should also be noted that the term “or” is generally employed in the sense of “and/or” unless the context clearly dictates otherwise.

Unless otherwise specified, the term “alkyl” or “alkyl group” refers to hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups, etc.).

Unless otherwise specified, the term “alkyl” includes both “unsubstituted alkyls” and “substituted alkyls.” The term “substituted alkyls” refers to alkyl groups having substituents replacing one or more hydrogens on one or more carbons of the hydrocarbon backbone. Such substituents may include, for example, alkenyl, alkynyl, halogena, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, phosphine, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including hetero aromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The present invention contemplates the possibility of omitting any components listed herein. The present invention further contemplates the omission of any components even though they are not expressly named as included or excluded from the invention.

The chemical structures herein are drawn according to the conventional standards known in the art. Thus, where an atom, such as a carbon atom, as drawn appears to have an unsatisfied valency, then that valency is assumed to be satisfied by a hydrogen atom, even though that hydrogen atom is not necessarily explicitly drawn. The structures of some of the compounds of this invention include stereogenic carbon atoms. It is to be understood that isomers arising from such asymmetry (e.g., all enantiomers and diastereomers) are included within the scope of this invention unless indicated otherwise. That is, unless otherwise stipulated, any chiral carbon center may be of either (R)- or (S)-stereochemistry. Such isomers can be obtained in substantially pure form by classical separation techniques and by stereochemically-controlled synthesis. Furthermore, alkenes can include either the E- or Z-geometry, where appropriate. In addition, the compounds of the present invention may exist in unsolvated as well as solvated forms with acceptable solvents such as water, THF, ethanol, and the like. In general, the solvated forms are considered equivalent to the unsolvated forms for the purposes of the present invention.

When used herein, HLB means Hydrophile-Lipophile Balance, which is an empirical expression for the relationship of the hydrophilic (“water-loving”) and hydrophobic (“water-hating”) groups of a surfactant. The higher the HLB value, the more water-soluble the surfactant. The HLB value for a surfactant can be determined, for example, by using methods known in the art, such as the Griffin method (Griffin, William C. (1949), “Classification of Surface-Active Agents by ‘HLB’”, Journal of the Society of Cosmetic Chemists, 1 (5): 311-26) and the Davies' method (Davies J T (1957), “A quantitative kinetic theory of emulsion type, I. Physical chemistry of the emulsifying agent,” Gas/Liquid and Liquid/Liquid Interface, Proceedings of the International Congress of Surface Activity, pp. 426-38).

The term “about” when used to modify a specified numeric value or quantity refers to variations in the numeric value or quantity that can occur by virtue of (a) typical measuring and liquid handling procedures that are used to make concentrates; (b) differences in the manufacture, source, or purity of the ingredients employed to make the present solutions, and the like. The term “about” also encompasses variations in value or quantity that may occur due to different equilibrium conditions of the present solutions. Whether or not modified by the term “about,” the claims include equivalents to the specified values or quantities due to the above factors. For the sake of clarity, the term “about” means a variation of ±5% to the expressed value.

### Monoalkyl Glycerol Ethers

Monoalkyl glycerol ethers are nonionic compounds based on a glycerin backbone, where the backbone is connected to one alkyl group through an ether linkage. The general molecular structure of this class of compounds is shown below:

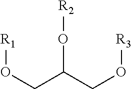

wherein any one of R1, R2 and R3 is a branched or unbranched, saturated or unsaturated, substituted or unsubstituted C1-C24 alkyl group, C6-C18 alkyl group, or C8-C12 alkyl group, and the other of R1, R2 and R3 are each hydrogen.

Example compounds include 1-dodecyl glycerol ether, 1-decyl glycerol ether, 1-heptyl glycerol ether, 1-octyl glycerol ether, 1-propyl glycerol ether, 1-octadecyl glycerol ether (batyl alcohol), 1-hexadecyl glycerol ether (chimyl alcohol) and 1-octadecenyl glycerol ether (selachyl alcohol). Other examples include 1-monoalkyl glycerol ethers having a saturated (branched or unbranched) C3 to C18-alkyl groups or saturated and branched C6- to C12-alkyl group. A specific example compound is 3-[(2-ethylhexyl)oxy]-1,2-propanediol (also referred to herein as 1-(2-ethylhexyl) glycerol ether sold in association with the trade name Sensiva® SC 50).

Monoalkyl glycerol ethers have low water solubility and very low mammalian and aquatic toxicity. They are readily biodegradable, non-sensitizing, and highly compatible with surface materials. Due to their excellent overall safety profile, monoalkyl glycerol ethers have (so far) found a preferred use in cosmetic and topical products.

These ingredients can be present in a concentration from about 0.01, 0.03, 0.1, 0.5, 1, 1.5, 2, 3, 5, 7, 10, 20, or 30% wt. and up to about 40, 30, 20, 15, 12, 10, 8, 7, 6, 5, or 4% wt.

### Nonionic Surfactants

Nonionic surfactants have a hydrophilic head that is not ionized, along with a hydrophobic tail often comprising carbonic structures. One or more of these are employed in compositions according to the invention. The nonionic surfactant must have an HLB value from about 6 to about 24, or from about 6 to about 14, as the inventor has surprisingly found that surfactants in this class act synergistically with the presently claimed glycerol ethers. When used herein, “synergy”, “synergistic”, “synergistically” or the like term, when used in reference to a combination of components (e.g. compounds or ingredients), means that the antimicrobial efficacy of the combination is greater than the sum of the antimicrobial efficacy of the components thereof.

The nonionic surfactants can be selected from fatty alcohol ethoxylates/propyloxylates (EO/PO,), alkyl pyrrolidones, block copolymers, alkyl polyglucosides, alkanolamines, ethoxylated alkanolamides, fatty acid esters, glycerol esters, and PEG esters, sorbitan esters, ethoxylated sorbitan esters, and alcohol ethoxylates. A more comprehensive list of nonionic surfactants useful in the context of the present invention can be found in detergent books and references such as Chapter 13, Nonionic Surfactants, Michael F. Cox, in the Handbook of Applied Surface and Colloid Chemistry, edited by Krister Holmberg, 2001, John Wiley & Sons or Handbook of Detergents, Part A: Properties, edited by Guy Broze, 1999, Marcel Dekker, all of which are incorporated herein by reference.

Alkyl pyrrolidones are a class of nonionic surfactants. They show a unique combination of surface activity and solvency. A combination of these surfactants with other anionic/nonionic surfactants further improves the wetting property of a solution in which they are present. They also have anti-corrosion properties, and can prevent rusting of low-grade medical instruments. The most effective alkyl chains are C6-C16, while C8-C12 are even more effective. Exemplary N-alkyl pyrrolidones are 1-octyl-2 pyrrolidone and 1-dodecyl-2-pyrrolidone shown below:

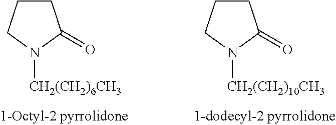

Examples of useful nonionic surfactants include C6-C24 primary or secondary fatty alcohols, C6-C24 alkoxylated primary or secondary fatty alcohols, alkyl pyrrolidones, C6-C24 polypropoxylated/polyethoxylated primary or secondary fatty alcohols, C6-C24 alkylpolyglucosides, C6-C24 alkylglucosides, C6-C24 alkyl glycerol esters, polyoxyethylene glycerol fatty acid esters, alkoxylated alkyl phenols, polysorbates, polyethoxylated tallow amines, amine oxides, alkanolamines, alkanolimides, amine ethoxylates, aminopolyols, polyol esters, and block copolymers.

These ingredients can be present in a concentration from about 0.01, 0.03, 0.1, 0.5, 1, 1.5, 2, 3, 5, 7, 10, 20, 30, or 40% wt. and up to about 60, 50, 40, 30, 20, 15, 12, 10, 8, 7, 6, 5, or 4% wt.

### Cationic Antimicrobials

Cationic antimicrobials include a wide range of compounds including bispyridiniumalkanes, biguanides, bisbiguanides, and quaternary ammonium compounds. These compounds are known to have an undesirable profile in regard to safety and toxicity and are therefore excluded from the present inventive compositions.

### Optional Ingredients

Longer chain glycerol ethers can have poor solubility in aqueous solution. Therefore, solubility-enhancing ingredients may be added. These ingredients can be any solubility-enhancing compound known to those skilled in the art, including organic solvents and anionic surfactants such as sodium xylene sulfonate, amphoteric surfactants, alcohols or polyols, ether or ester based solvents, and emulsifiers.

Further optional ingredients for other purposes may include, without limitation, water, enzymes, anionic surfactants, carboxylic acids, cationic surfactants (other than bispyridiniumalkanes), amphoteric surfactants, other nonionic surfactants, stabilizing agents, skin conditioning agents, additional antimicrobial agents, other solvents, hydrotropes, water soluble polymers, chelating agents, brighteners, corrosion inhibitors, pH buffers and adjusters, dyes, fragrances, rheology modifiers, organic or inorganic salts, defoaming agents, bleaching agents, deodorizing agents, builders, fillers, soil anti-redeposition agents, antioxidants, lubricants, and polyols.

For increased antimicrobial activity, other known antimicrobial active ingredients can added including, without limitation, peroxide and peracid compounds, phenols and phenolic compounds, aldehydes, halogen compounds, essential oils, quaternary ammonium compounds, organic acids, alcohols and mixtures thereof. The specific choice of these ingredients will depend on the purpose and application of the composition.

### Hydrotropes

Hydrotropes or “coupling agents” are organic compounds which increase the capacity of water to dissolve other chemicals. They are mostly used in water-based detergent compositions comprising high amounts of surfactants and low water-soluble ingredients. The addition of hydrotropes to such solutions allows a clear, isotropic and shelf-stable solution to be achieved. Commonly used hydrotropes include sodium xylene sulfonates, sodium toluene sulfonates, sodium cumene sulfonates, and alkyl sulfonates.

### Polyols

Polyols are alcohols containing multiple hydroxyl groups. Sugar alcohols are a commonly used class of polyols (e.g. glycerol, sorbitol, maltitol, xylitol, isomalt, erythritol). One type of polyol is glycols, which are alcohols with two hydroxyl groups. Glycols which may be used in solutions according to the invention include but are not limited to propylene glycol and butylene glycol. It is believed that polyols reduce the water availability and therefore improve the stability of any enzymes in solution.

### Anionic Surfactants

An anionic surfactant is a compound having a hydrophilic head that comprises an anion typically a sulfonate, sulfate or carboxylate moiety. Any anionic surfactants may be used in the present inventive composition. For example, the anionic surfactant may be chosen from linear or branched alkyl aryl sulfonic acids and their alkali metal, ammonium, calcium and magnesium salts, sulfonated C12 to C22 carboxylic acids and alkali metal, ammonium, calcium and magnesium salts thereof, C6 to C22 alkyl diphenyl oxide sulfonic acids and alkali metal, ammonium, calcium and magnesium salts thereof, naphthalene sulfonic acids and alkali metal, ammonium, calcium and magnesium salts thereof, C8 to C22 alkyl sulfonic acids and alkali metal, ammonium, calcium and magnesium salts thereof, alkali metal, ammonium, calcium and magnesium C8 to C18 alkyl sulfates, alkyl or alkenyl esters or diesters of sulfosuccinic acid in which the alkyl or alkenyl groups independently contain from six to eighteen carbon atoms and alkali metal, ammonium, calcium and magnesium salts thereof, and mixtures thereof. Of the sulfonated C12 to C22 carboxylic acids and their aforesaid salts, sulfonated 9-octadecanoic acid, disodium 2-sulfo C12-C18 fatty acid salts and sodium methyl-2-sulfo C12-C16 esters are exemplary. An exemplary salt of naphthalene sulfonic acid is sodium alkyl naphthalene sulfonate. Exemplary salts of C8 to C22 alkyl sulfonic acids are sodium octyl (C8) sulfonate, sodium C14-C17 sec-alkyl sulfonate, and the sodium salts of 1-octane sulfonic acid, 1-decane sulfonic acid, and tridecane sulfonic acid. Of the aforesaid C8 to C18 alkyl sulfates, sodium lauryl sulfate and sodium octyl sulfate are exemplary.

### Carboxylic Acids

In some embodiments, the solutions or compositions may comprise at least one cyclic or linear, branched or unbranched, saturated or unsaturated, substituted or unsubstituted, mono-, di- or poly-carboxylic acid. The carboxylic acid may be chosen from C1 to C22 carboxylic acids. In some embodiments, the carboxylic acid may be a C5 to C11 carboxylic acid. In some embodiments, the carboxylic acid may be a C1 to C4 carboxylic acid. Examples of suitable carboxylic acids include but are not limited to 2-furoic acid, salicylic acid, benzoic acid, citric acid, sulfosalicylic acid, sulfosuccinic acid, glycolic acid, lactic acid, formic acid, oxalic acid, malic acid, acetic acid, propionic acid, butanoic acid, pentanoic acid, hexanoic acid, heptanoic acid, octanoic acid, nonanoic acid, decanoic acid, undecanoic acid, dodecanoic acid, as well as their branched isomers, maleic acid, ascorbic acid, alpha-or-beta hydroxy-acetic acid, neopentanoic acid, neoheptanoic acid, neodecanoic acid, malonic acid, succinic acid, glutaric acid, adipic acid, pimelic suberic acid, and mixtures thereof. Some embodiments will have at least one acid and/or salt selected from the group consisting of salicylic acid, 2-furoic acid, benzoic acid, and salts thereof.

### Chelating Agents

Chelating agents are typically used in detergent formulations to counter the detrimental effects of metal ions. The mechanism is through complexing metal ions by formation of one or more stable heteroatom rings around them. The complexes are water-soluble and the metal complexes will not have the same chemical activity as their free metal ions. Useful chelating agents may be chosen from, without limitation, 2-hydroxyethyliminodiacetic acid (HEIDA), iminodisuccinic acid, polyaspartic acid, N-polysuccinic acids, glutamic acid diacetic acid, methylglycinediacetic acid, ethylenediamine-N,N′-disuccinic acid, phosphoric acid (H3PO4) and phosphonic acids such as 1-hydroxyethylidene-1,1-diphosphonic acid (HEDP), amino tri(methylene phosphonic acid) (ATMP), diethylenetriamine penta(methylene phosphonic acid), 2-hydroxy ethylimino bis(methylene phosphonic acid), phytic acid, ethylene diamine tetra(methylene phosphonic acid) (EDTMPA), and salts thereof.

Tests were performed using the following ingredients.

### Ingredient—(Trade Name, if Applicable)—Concentration—Manufacturer

### Monoalkyl Glycerol Ether

Ethylhexylglycerin (also called 3-[(2-ethylhexyl)oxy]-1,2-propanediol)—Sensiva® SC 50->95% wt. from Schulke Inc.

### Nonionic Surfactants

Poly(ethylene glycol)-block-poly(propylene glycol)block-poly(ethylene glycol)—Pluronic 25R2—100% wt. solution from BASF

Polyoxypropylene-polyoxyethylene Block Copolymer—Pluronic L-64—100% wt. solution from BASF

N-Octyl-2-Pyrrolidone—Surfadone LP-100->99.5% wt. solution from BASF

Fatty alcohol C12-C14 with approx. 3 moles EO and approx. 6 moles PO—Dehypon LS 36—60% to 100% wt. solution from BASF

Fatty alcohol C12-C14 with approx. 5 moles EO and approx. 4 moles PO—Dehypon LS 54->99.5% wt. solution from BASF

Alkylpolyglycoside C10-16—Glucopon 600 UP—30% to 60% wt. solution from BASF

Ethoxylated Alcohols, C6-C12—Alfonic L610-3.5—100% wt. solution from Sasol Inc.

Secondary alcohol ethoxylates—Tergitol 15-S-7->97% wt. solution from Dow Chemicals

Ethoxylated Alcohols, C9-11—Tomadol 91-2.5—100% wt. solution by Air Products

### Organic and Inorganic Salts

Sodium formate—100% wt. compound from JOST Chemical Co.

Calcium chloride, dihydrate—100% wt. compound from Pharmco-Aaper

### Acid

Boric acid->99% wt. compound from Optibor

### Polyols

Propylene glycol—>99.8% wt. solution from Univar

Sorbitol—70% wt. solution from Polyrheo

Glycerol—100% wt. solution from BDH

### Chelating Agent

Alanine, N,N-bis(carboxymethyl)-, trisodium salt—Trilon M—35% to 45% wt. solution from BASF

### Enzyme

Subtilisin-derived protease enzyme with 2.5 AU-A/g—Alcalase Ultra—1% to 5% wt. solution from Novozymes

### Hydrotrope

Sodium xylene sulphonate—Stepanate SXS—40% to 50% wt. solution from Stepan

### EXAMPLES

Tests were done to evaluate the antimicrobial activity of various ingredients and ingredient combinations, as well as to assess the minimum concentration of ingredients sufficient to bring antimicrobial efficacy to a solution. The tests were done using low concentrations of the ingredients and at elevated temperatures against S. aureus, a hardy gram positive bacteria that is capable of forming hard-to-kill spores at such high temperatures. Tables 1 and 2 illustrate various formulations and their efficacy against S. aureus using the ASTM 2315-03 time kill assay, at 50° C. using a 5-minute contact time. In the below tables, the actual amount (% w/w) of each ingredient in solution is shown.

TABLE 1

| Ingredient | A1 | A2 | A3 | A4 | A5 | A6 |
|---|---|---|---|---|---|---|
| Water | Q.S. | Q.S. | Q.S. | Q.S. | Q.S. | Q.S. |
| | to 100 | to 100 | to 100 | to 100 | to 100 | to 100 |
| Ethylhexylglycerin | 0.04 | — | 0.04 | 0.04 | 0.04 | 0.04 |
| Poly(ethylene | — | 0.01 | 0.01 | 0.01 | — | — |
| glycol)-block- | | | | | | |
| poly(propylene | | | | | | |
| glycol)-block- | | | | | | |
| poly(ethylene glycol) | | | | | | |
| N-Octyl-2- | — | 0.033 | 0.033 | 0.033 | — | — |
| Pyrrolidone | | | | | | |
| Fatty alcohol C12- | — | 0.01 | 0.01 | 0.01 | — | — |
| C14 with approx. 3 | | | | | | |
| moles EO and | | | | | | |
| approx. 6 moles PO | | | | | | |
| Fatty alcohol C12- | — | 0.01 | 0.01 | 0.01 | — | — |
| C14 with approx. 5 | | | | | | |
| moles EO and | | | | | | |
| approx. 4 moles PO | | | | | | |
| Sodium xylene | — | 0.05 | 0.05 | — | 0.05 | — |
| sulphonate | | | | | | |
| Boric acid | — | 0.015 | 0.015 | — | 0.015 | 0.015 |
| Propylene glycol | — | 0.1 | 0.1 | — | 0.1 | — |
| Glycerol | — | 0.025 | 0.025 | — | 0.025 | — |
| Sorbitol | — | 0.025 | 0.025 | — | 0.025 | — |
| Sodium formate | — | 0.0025 | 0.0025 | — | — | 0.0025 |
| Calcium chloride, | — | 0.0005 | 0.0005 | — | — | 0.0005 |
| dehydrate | | | | | | |
| Subtilisin-derived | — | 0.02 | 0.02 | — | 0.02 | 0.02 |
| protease enzyme | | | | | | |
| with 2.5 AU-A/g | | | | | | |
| Alanine, N,N- | — | 0.008 | 0.008 | — | — | — |
| bis(carboxymethyl)-, | | | | | | |
| trisodium salt | | | | | | |
| S. aureus Log | 0.2 | 3.4 | >5.5 | >5.1 | 0.0 | 0.0 |
| Reduction: | | | | | | |

Solution A1 is not in accordance with the invention as it lacks a nonionic surfactant and achieved a mere 0.2 log reduction of bacteria. Solution A2 is also not in accordance with the invention as it comprises a combination of regularly used cleaning ingredients (including nonionic surfactants) but lacks a monoalkyl glycerol ether. Solution A2, achieved a background level of antimicrobial activity, specifically, a 3.4 log reduction of bacteria. Solution A3 is in accordance with the invention and produced a >5.5 log reduction in bacteria, a result that is synergistic as compared to the results for Solutions A1 and A2.

Solution A4 is also in accordance with the invention and comprises a mixture of monoalkyl glycerol ether and nonionic surfactants. The result is comparable to that of Solution A3.

Solutions A5 and A6 are not in accordance with the invention as they lack the essential nonionic surfactants. These solutions were wholly ineffective under the conditions of the test—both achieved a zero log reduction in bacteria. These results show that the polyols, sodium xylene sulfonate, boric acid, salts and enzyme do not contribute to antimicrobial efficacy.

TABLE 2

| Ingredient | A7 | A8 | A9 | A10 | A11 | A12 | A13 | A14 | A15 | A16 |
|---|---|---|---|---|---|---|---|---|---|---|
| Water | Q.S. | Q.S. | QS. | Q.S. | Q.S. | Q.S. | Q.S. | Q.S. | Q.S. | Q.S. |
| | to 100 | to 100 | to 100 | to 100 | to 100 | to 100 | to 100 | to 100 | to 100 | to 100 |
| Ethylhexylglycerin | 0.04 | 0.04 | 0.04 | 0.04 | 0.04 | 0.04 | 0.04 | 0.04 | 0.04 | 0.04 |
| N-Octyl-2- | — | — | — | — | — | — | 0.033 | 0.033 | — | 0.033 |
| pyrrolidinone | | | | | | | | | | |
| (HLB: 6) | | | | | | | | | | |
| Fatty alcohol C12- | — | 0.033 | — | — | — | — | — | — | — | 0.01 |
| C14 with approx. | | | | | | | | | | |
| 3 moles EO and | | | | | | | | | | |
| approx. 6 moles | | | | | | | | | | |
| PO (HLB: 4) | | | | | | | | | | |
| Fatty alcohol C12- | — | — | 0.033 | — | — | — | — | — | — | 0.01 |
| C14 with approx. | | | | | | | | | | |
| 5 moles EO and | | | | | | | | | | |
| approx. 4 moles | | | | | | | | | | |
| PO (HLB: 6) | | | | | | | | | | |
| Polyoxypropylene- | 0.033 | — | — | — | — | — | 0.01 | — | — | — |
| polyoxyethylene | | | | | | | | | | |
| Block Copolymer | | | | | | | | | | |
| (HLB: 4) | | | | | | | | | | |
| Alkylpolyglycoside | — | — | — | — | 0.033 | — | — | — | — | — |
| C10-16 (HLB: | | | | | | | | | | |
| 11.6) | | | | | | | | | | |
| Ethoxylated | — | — | — | — | — | 0.033 | — | — | — | — |
| Alcohols, C6-C12 | | | | | | | | | | |
| (HLB: 10.4) | | | | | | | | | | |
| Secondary alcohol | — | — | — | 0.033 | — | — | — | — | — | — |
| ethoxylates (HLB: | | | | | | | | | | |
| 12.1) | | | | | | | | | | |
| Ethoxylated | — | — | — | — | — | — | — | — | 0.033 | — |
| Alcohols, C9-11 | | | | | | | | | | |
| (HLB: 8.5) | | | | | | | | | | |
| S. aureus Log | 0.1 | 0.3 | 2.0 | 3.0 | 3.2 | 3.9 | 4.3 | 4.5 | >5.7 | >5.7 |
| Reduction: | | | | | | | | | | |

Solutions A7 to A16 employ ethylhexylglycerin in combination with different classes of nonionic surfactants. The results demonstrate the criticality of using nonionic surfactants having an HLB value of at least about 6. Solutions A7 and A8 employ nonionic surfactants having an HLB value of about 4 and resulted in a 0.1 and 0.3 log reduction in bacteria, respectively. The other solutions (A9-A16) with nonionic surfactants having HLB values of about 6 or higher resulted in 2 log reduction in bacteria. Solutions A15 and A16 were most effective—each achieved a greater than 5.7 log reduction in bacteria under the conditions of the test.

It will be appreciated that the scope of the invention is not to be limited to the preferred embodiments set forth in the examples, but should be given the broadest interpretation consistent with the description and claims.

1. A synergistic antimicrobial composition comprising:
a. at least one monoalkyl glycerol ether according to formula I 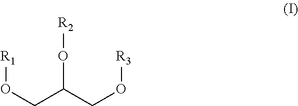
wherein any one of R1, R2 and R3 is a branched or unbranched, saturated or unsaturated C1-C24 alkyl group and the other of R1, R2 and R3 are each hydrogen; and
b. at least one nonionic surfactant having an HLB value of from about 6 to about 24;
wherein the composition is free of cationic antimicrobial compounds.

2. The composition of claim 1, wherein the at least one nonionic surfactant having an HLB value of from about 6 to about 24 is selected from the group comprising C6-C24 primary or secondary fatty alcohols, C6-C24 alkoxylated primary or secondary fatty alcohols, alkyl pyrrolidones, C6-C24 polypropoxylated/polyethoxylated primary or secondary fatty alcohols, C6-C24 alkylpolyglucosides, C6-C24 alkylglucosides, C6-C24 alkyl glycerol esters, polyoxyethylene glycerol fatty acid esters, alkoxylated alkyl phenols, polysorbates, polyethoxylated tallow amines, amine oxides, alkanolamines, alkanolimides, amine ethoxylates, aminopolyols, polyol esters, and block copolymers.

3. The composition of claim 1, wherein the at least one monoalkyl glycerol ether is present in a concentration of from about 0.01% wt. to about 40% wt.

4. The composition of claim 1, wherein the at least one nonionic surfactant is present in a concentration of from about 0.01% wt. to about 60% wt.

5. The composition of claim 1, further comprising water.

6. The composition of claim 5, wherein the pH is from about 2 to 12.

7. The composition of claim 6, wherein the pH is from about 5 to 10.

8. The composition of claim 7, wherein the pH is from about 6 to 8.

9. The composition of claim 1, wherein the at least one monoalkyl glycerol ether is selected from the group comprising 3-[(2-ethylhexyl)oxy]-1,2-propanediol, 1-dodecyl glycerol ether, 1-decyl glycerol ether and 1-heptyl glycerol ether.

10. The composition of claim 1, wherein any one of R1, R2 and R3 is a branched or unbranched, saturated or unsaturated C6-C18 alkyl group and the other of R1, R2 and R3 are each hydrogen.

11. The composition of claim 1, wherein any one of R1, R2 and R3 is a branched or unbranched, saturated or unsaturated C8-C12 alkyl group and the other of R1, R2 and R3 are each hydrogen.

12. The composition of claim 1, wherein the at least one monoalkyl glycerol ether is 3-[(2-ethylhexyl)oxy]-1,2-propanediol.

13. The composition of claim 1, wherein the nonionic surfactant has an HLB value of from about 6 to about 14.

14. The composition of claim 1, further comprising at least one component chosen from enzymes, anionic surfactants, carboxylic acids, amphoteric surfactants, other nonionic surfactants, stabilizing agents, skin conditioning agents, additional antimicrobial agents, solvents, hydrotropes, wetting agents, water soluble polymers, chelating agents, brighteners, corrosion inhibitors, pH buffers and adjusters, dyes, fragrances, rheology modifiers, inorganic salts, defoaming agents, bleaching agents, deodorizing agents, builders, fillers, anti-redeposition agents, antioxidants, lubricants, and polyols.

15. A ready-to-use composition according to claim 1, wherein the at least one monoalkyl glycerol ether is present in a concentration of from about 0.01% wt. to about 10% wt.; and the at least one nonionic surfactant is present in a concentration of from about 0.01% wt. to about 10% wt.

16. The ready-to-use composition of claim 15, wherein the at least one monoalkyl glycerol ether is present in a concentration of from about 0.01% wt. to about 5% wt.; and the at least one nonionic surfactant is present in a concentration of from about 0.01% wt. to about 5% wt.

17. A concentrated composition according to claim 1, wherein the at least one monoalkyl glycerol ether is present in a concentration of from about 1% wt. to about 40% wt.; and the at least one nonionic surfactant is present in a concentration of from about 2% wt. to about 60% wt.

18. The concentrated composition of claim 17, wherein the at least one monoalkyl glycerol ether is present in a concentration of from about 5% wt. to about 20% wt.; and the at least one nonionic surfactant is present in a concentration of from about 7% wt. to about 30% wt.

19. A method of reducing microbial load on a surface which comprises applying to the surface a composition according to claim 1.

20. A method of preserving a water-containing product comprising adding the composition according to claim 1 to the product.
